(19) United States
(12) Patent Application Publication
(10) Pub. No.: US 2005/0132913 A1
(43) Pub. Date: Jun. 23, 2005

(54) Apparatus for cleaning rolls, cylinders and printing forms

(75) Inventors: Josef Gottling, Friedberg (DE); Dieter Schmid, Todtenweis (DE); Josef Schneider, Diedorf (DE); Jurgen Schuster, Augsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach am Main (DE)

(21) Appl. No.: 11/015,174

(22) Filed: Dec. 17, 2004

(30) Foreign Application Priority Data
Dec. 19, 2003 (DE) 103 60 011.6

(51) Int. Cl. B41F 35/00

(52) U.S. Cl. 101/425

(57) ABSTRACT

An apparatus for cleaning and/or removing images from surfaces, in particular from roll or cylinder surfaces or printing forms is provided. The cleaning apparatus includes one or more blasting nozzles for discharging water in the form of crystalline ice particles or CO₂ particles/pellets onto the surfaces to be cleaned. The discharging crystalline ice or CO₂ particles effectively remove dirt particles or ink-carrying polymers from the surface to be cleaned. The dislodged material and the waste ice, which may have changed into water droplets, are removed from the surface and taken away.

### FIELD OF THE INVENTION

This invention pertains to an apparatus for cleaning rolls, cylinders and printing forms. The invention relates in particular to an apparatus for cleaning components that have to be cleaned in presses or outside presses.

### BACKGROUND OF THE INVENTION

Components associated with printing applications that need to be cleaned include in particular rolls used in the presses, such as paper guide rolls and other transport rolls, and also cylinders needed in the printing units, such as blanket cylinders and printing form or plate cylinders. Printing form or plate cylinders can carry printing plates clamped onto their surfaces or can be provided with sleeves that can be pushed axially onto the plate cylinder. While the surfaces of the printing rolls merely have to be cleaned of dirt, such as paper dust or printing ink (which is also true of the blanket cylinders), in the case of form or plate cylinders fitted with plates, the printing form used must be removed from the surface of the plate or the sleeve after a print job or printing operation has been carried out. In other words, the plate or the sleeve must be erased in order to remove its image. In such a case, the ink-carrying polymer layers that have normally been produced during the production, i.e. during imaging of the plate or the sleeve, must be removed by what are known as laser imaging methods.

The cleaning of such printing forms is already known. In particular, removing their images, by using cleaning apparatuses having cloths is known. The cleaning apparatuses having cloths aid removal of paper dust, printing ink and the ink-carrying polymer from plate-like or sleeve-like printing forms. Moreover, it is also already known to use a pressurized solvent-free water jet to erase or remove the ink-carrying layers of the printing forms imaged by a thermal transfer method and suitable for offset printing. The water jet is aimed obliquely at the imaged surface of the printing area at a predefined angle with a relative movement between the printing form and the erasing apparatus being carried out. The cleaning or image removal achieved with such apparatuses is frequently inadequate, particularly where highly adhesive dirt particles or polymer layers are concerned.

Methods are also known in which solid materials, for example baking powder, nutshells, corundum, glass or dry ice pellets, are blasted using compressed air onto the contaminated rolls or cylinders. The disadvantage with this method is that these procedures generally have to be carried out outside the press, and thus the rolls or cylinders always have to be removed. In addition, the materials used for blasting the rolls and cylinders are expensive and frequently are subject to special industrial waste disposal procedures. A further substantial disadvantage of this method is that the surfaces of the rolls or cylinders are subject to damage as a result of the abrasive effects of the blasting process.

### BRIEF SUMMARY OF THE INVENTION

In view of the foregoing, an object of the present invention is to provide effective ways of cleaning roll and cylinder surfaces and, in particular, of erasable imaged printing form surfaces, that can be performed inside and outside the press without any potential for abrasion or scratching of the surfaces to be cleaned.

The present invention has the particular advantage that it involves only non-abrasive cleaning methods. Moreover, only minimum waste is produced during the cleaning, no dust is produced. Thus, the maintenance costs are low. The blasting material also does require any special waste disposal procedures and the application of chemicals is not necessary. In addition to all these advantages, the invention provides effective, very good cleaning of the surfaces of the rolls, cylinders and printing forms.

### BRIEF DESCRIPTION OF THE DRAWINGS

FIG. 1 is a schematic view of an exemplary cleaning apparatus according to the invention.

FIG. 2 is a schematic view of a further embodiment of a cleaning apparatus according to the invention having a cleaning chamber.

FIG. 3 is a schematic view of a particular embodiment of a cleaning chamber.

### DETAILED DESCRIPTION OF THE INVENTION

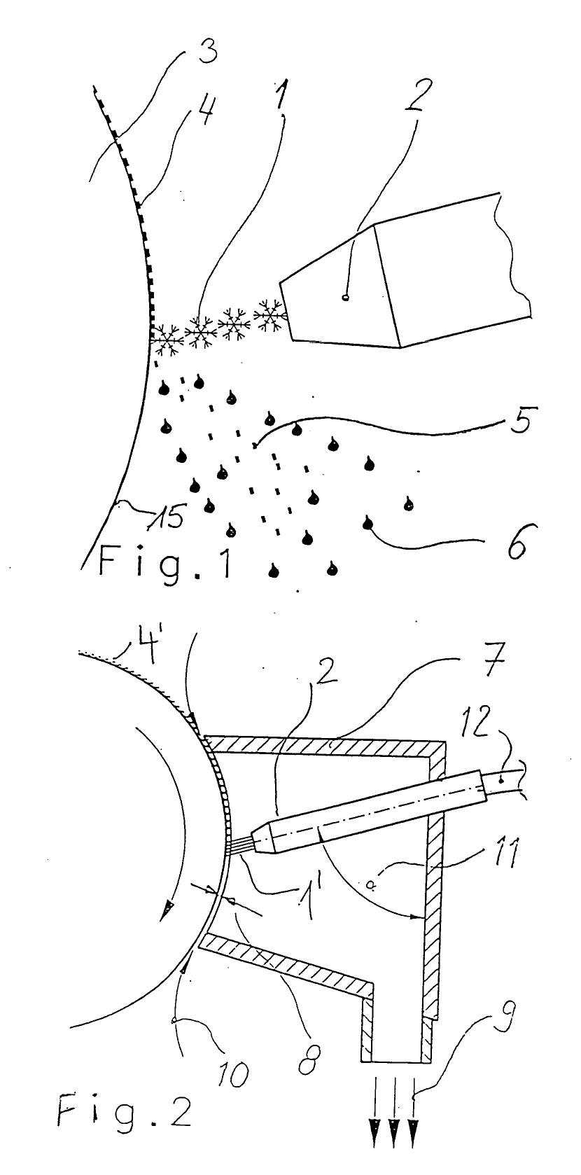

Referring now to FIG. 1 of the drawings, a cleaning apparatus according to the invention is schematically shown. The illustrated cleaning apparatus is particularly suitable for direct use in a press, specifically a rotary offset press. However, it will be understood that within the context of the possible application of the present invention use outside the press is also possible. When being used outside the press, the rolls, the cylinders, the components carrying the printing form parts, the printing form sleeve or printing plate (if appropriate), together with the associated cylinder have to be removed from the printing machine, so that the cleaning or image removal according to the invention can be carried out in a separate apparatus.

According to an important aspect of the invention, ice particles 1 are used that are preferably discharged at high pressure from a blasting nozzle 2 at the surface of a cylinder 3. The surface of the cylinder can have, for example, dirt particles, such as dust, paper particles, undesired ink or ink particles, if the cleaning of rolls or cylinders such as blanket cylinders is concerned. The invention has particular advantages if laser-imaged printing forms are to have their images removed (i.e. the ink-carrying surface, usually a polymer, is to be removed) after a printing operation or print job has been carried out. The jet of ice particles 1, what is referred to the ice blaster, is applied at high pressure (e.g., approximately 7-12 bar) to the surface of the substrate or cylinder 3 to be cleaned, which typically carries a printing plate or a printing form sleeve. When the ice particles 1 strike the surface of the substrate to be cleaned (e.g., a cylinder 3 carrying a printing form), the dirt or polymer particles 4 located on the printing form are removed in a highly effective manner. In this case, it is a substantial advantage that, while the surface to be cleaned or from which the image is to be removed is cleaned effectively, the surface is not damaged due to the structure of the crystalline water ice used in the ice jet. This is in sharp contrast to the massive undesired mechanical forces that can be a problem when cleaning using brushes or cloths.

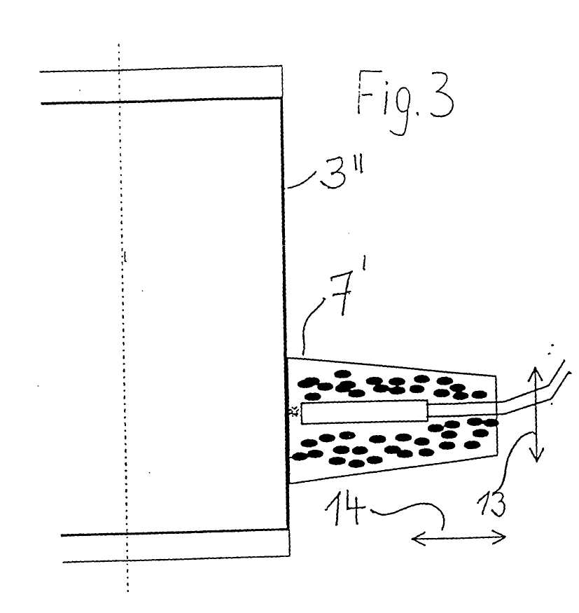

When the ice particles strike the surface to be cleaned, the ice particles have already liquefied as a result of the ambient temperature (as shown at 6 in FIG. 1). This is a further advantage of the invention since the result of this liquefaction is that the coatings 4 removed from the cylinder surfaces in the form of dirt or polymer particles 5 are floated off in the water produced by the liquefaction and washed away. Thus, the removed dirt and polymer particles can be transported away in a straightforward manner via cleaning chambers such as shown in FIG. 2. The surface of the cylinder 3 to which the coating 4 is applied in the form of an ink-carrying polymer is designated with reference number 15 in FIG. 1.

An embodiment of the invention in which use is made of a blasting chamber 7 is schematically shown in FIG. 2. The blasting chamber preferably can be set against the roll or cylinder 4′ within a press. The nozzle 2 used in this blasting chamber 7 is aimed at the roll or cylinder 4′ at a predefined angle 11 (also designated a) so that the ice particle jet 1′ passes from the blasting nozzle 2 to the surface of the cylinder or the roll. In this case, a feed line 12 feeds the nozzle. The blasting chamber 7 is arranged at a distance from the roll or cylinder 4′ with the aid of a seal 8. The seal 8, for example rubber lips or brushes, seals the blasting chamber 7 against the surface of the roll or cylinder 4′. Moreover, the blasting chamber can be operated under vacuum. As a result, the particles and water droplets present in the blasting chamber 7 are extracted with external air also being drawn in through the gap seal 8 so that ice crystals, dirt and water do emerge at the seal. In particular, the ice crystals, dirt and water are transported away from the blasting chamber 7 by means of a vacuum source 9. The external air 10 in this case flows under the gap seal 8 as shown in FIG. 2.

In utilizing the principles of the present invention, in simple embodiments only one blasting nozzle 2 can be used in a blasting chamber 7. Alternatively, in the case of wide rolls or cylinders or printing forms, a plurality of blasting nozzles 2 can be arranged beside one another. Such an arrangement would of course increase the cleaning speed without any movement of the blasting chamber 7 being required.

A blasting chamber 7′ is illustrated in FIG. 3 which is substantially narrower than the surface to be cleaned or narrower than the length of a cylinder or roll 3″ to be cleaned. In this case, the blasting chamber 7′ can be moved in the direction of the arrow 13 while the cylinder or roll 3″ to be cleaned is rotating. The distance of the blasting chamber 7′ from the cylinder or roll 3″ can be adjusted in the direction of the arrow 14, which is necessary in particular when cylinders, rolls or sleeves of different sizes, i.e. different diameters, are to be cleaned or have their images removed.

If cleaning performed in the machine is not desired, a cleaning chamber arranged outside the machine can be used. The rolls, cylinders or sleeves to be cleaned can then be introduced into the outside cleaning chamber after appropriate removal from the press. As will be appreciated, with such an arrangement, an appropriate mounting apparatus for the parts to be cleaned is necessary, in order also to permit rotation of these parts during the cleaning operation. As a result of the change of the ice particles or crystalline particles (ice blaster) as they strike the surface to be cleaned even at ambient temperature, both effective cleaning and image removal are achieved. In addition, the cleaning and image removal is done in a gentle manner since, as opposed to the use of hard particles, there is no undesired impairment of the surfaces to be cleaned, even by hard ice particles. For the production of the crystalline ice jet needed to implement the invention, commercially available equipment can be used.

Instead of the crystalline ice particle jets already described, CO₂ pellets or particles can also be used with the present invention. It is likewise possible to carry out cleaning and image removal from surfaces of components of printing presses, for example by using the cleaning apparatuses described above, using CO₂ pellets. The CO₂ pellets are applied at an appropriate pressure to the surfaces to be cleaned.

1. An apparatus for cleaning roll or cylinder surfaces or imaged printing form surfaces comprising a blasting nozzle for discharging a pressurized jet of ice or CO₂ particles, the blasting nozzle being arranged to discharge at an angle relative to the surface to be cleaned such that residue material on the surface to be cleaned is detached from the surface.

2. A clearing apparatus according to claim 1, wherein the blasting nozzle is arranged with a corresponding feed line in a cleaning chamber and further including a vacuum source, the vacuum source being in communication with the chamber for extracting from the cleaning chamber material detached from the surface to be cleaned along with the ice or CO₂ particles that have struck the surface.

3. A cleaning apparatus according to claim 2, wherein the cleaning chamber is positioned on a cylinder in a printing press.

4. A cleaning apparatus according to claim 3, wherein the cleaning chamber is movable along the cylinder while the cylinder is rotating so that the entire cylinder surface is cleaned.

5. A cleaning apparatus according to claim 1, wherein the material removed from the surface to be cleaned includes ink-carrying polymer layers of a printing form.

6. A cleaning apparatus according to claim 2, wherein the cleaning chamber is separated by a gap seal from the surface to be cleaned.

7. A cleaning apparatus according to claim 6, wherein the gap seal utilizes rubber lips or brushes as sealing elements.

8. A cleaning apparatus according to claim 6, wherein a supply of external air flows into the cleaning chamber through the gap seal when the vacuum source is applied to the cleaning chamber.

9. A cleaning apparatus according to claim 1, wherein the jet of ice or CO₂ particles is at a pressure of approximately 7-12 bar.

10. A cleaning apparatus according to claim 1, wherein the surface to be cleaned is a sleeve-like offset printing form from which an image is to be removed.

11. An apparatus for cleaning roll or cylinder surfaces or imaged printing form surfaces comprising a blasting nozzle for discharging a pressurized jet of blasting material, the blasting nozzle being arranged to discharge at an angle relative to the surface to be cleaned such that residue material on the surface to be cleaned is detached from the surface, the blasting material being a solid particulate matter able to change to a liquid or gas at ambient temperature and pressure without harming the surface to be cleaned.

12. A method for cleaning roll or cylinder surfaces or imaged printing form surfaces comprising discharging a pressurized jet of blasting material at an angle relative to a surface to be cleaned, the blasting material being a solid particulate matter able to change to a liquid or gas at ambient temperature and pressure without harming the surface to be cleaned.
